(19) United States
(12) Patent Application Publication
(10) Pub. No.: US 2026/0312373 A1
(43) Pub. Date: Oct. 8, 2026

(54) SPARK PLUG INSPECTION ASSEMBLY

(71) Applicant: Myron Hill, Chelsea, MI (US)

(72) Inventor: Myron Hill, Chelsea, MI (US)

(21) Appl. No.: 19/539,925

(22) Filed: Feb. 13, 2026

Related U.S. Application Data
(60) Provisional application No. 63/759,790, filed on Mar. 3, 2025.

(51) Int. Cl. H01T 13/58; H04N 23/56

(52) U.S. Cl. CPC H01T 13/58; H04N 23/56

(57) ABSTRACT

A spark plug inspection assembly for inspection of spark plugs and spark plug parameters that includes a base having an analysis socket configured for moveable orientation of the spark plug under inspection as well as a plurality of holder sockets that can maintain spark plugs in an orderly organized manner together with a fixture and support arm configured to maintain an inspection device in fixed relationship relative to the sparkplug undergoing visual inspection. The spark plug inspection assembly provides a magnification assembly and method for portable digital spark plug inspection that allows for enhanced analysis and documentation of the spark plug.

### CROSS-REFERENCE TO RELATED APPLICATION(S)

This application claims priority to and the benefit of U.S. Provisional Patent Application Ser. No. 63/759,790, filed Feb. 18, 2025, the entire disclosure of which is hereby incorporated by reference.

### TECHNICAL FIELD

This disclosure relates to a spark plug assembly.

### BACKGROUND

Spark plugs are integral to spark-ignition internal combustion engines, which operate on fuels that require an external ignition source, for example gasoline, liquefied petroleum gas (LPG), liquefied natural gas (LNG), alcohols, and hydrogen. A spark plug generates an electric spark across a gap between a ground electrode and a center electrode, which can cause ignition of a provided air-fuel mixture within a combustion chamber to combust. The spark initiates combustion of the mixture, releasing chemical energy as thermal energy that increases pressure within the cylinder and drives the piston to produce mechanical work.

The performance of a combustion engine is often evaluated by visually inspecting spark plugs for indicators of engine performance. These signs include soot accumulation, discoloration, and timing accuracy. Traditionally, this inspection has been performed using a handheld magnification device. However, this method has several limitations including: hand movement which reduces image stability, an average magnification of only 3×-11×, difficult to see the interior cavity, using a magnifying glass is uncomfortable thus limits inspection duration, there is no ability to capture the image for future reference, the solo viewing experience prevents group discussions around one central perspective and at times spark plugs are cut open for a deeper interior analysis which can pose safety risks due to flying metal debris.

To facilitate combustion in an internal combustion engine, spark plugs have a variety of parameters that may need inspection and subsequent adjustment. Spark plugs can be made of material that is prone to cracking and chipping, and the gap between the ground electrode and center electrode may need adjusting, whether the spark plug is new out of the box or being inspected as a part of routine maintenance of an internal combustion engine.

Spark plugs can also showcase performance of an engine, particularly if it is running too hot, if there is too much or too little fuel, additional wear, and the timing calibration of the engine. Thus, an inspection assembly is desirable to inspect spark plug parameters and other engine related indicators.

Typical spark plug inspection assemblies are bulky, stationary, and may be found at the end of a manufacturing line as part of manufacturing quality assurance operations. However, there exists a need to inspect spark plugs in the field and at various remote locations including but not limited to racetracks, individual garages and the like to assess and/or diagnose engine performance.

Thus, it would be desirable to provide a spark plug inspection assembly that is portable and can include a self-contained power source such as a battery. It would also be desirable to provide a spark plug assembly that can facilitate inspection of the spark plug from one or more angles. It is also desirable to provide a spark plug inspection device that can facilitate the organized analysis of one or more speak plugs, for example from a specific engine and/or a specific cylinder in a given engine, in order to assist in the assessment of engine performance. It is also desirable to provide a spark plug assembly that facilitates inspection by humans using one or more visualization devices.

### SUMMARY

Disclosed herein are implementations of a spark plug inspection assembly that includes a base having a plurality of legs, an analysis socket configured to receive a spark plug along an inspection axis, and one or more holder sockets configured to temporarily retain additional spark plugs, the base providing a stable platform for spark plug inspection.

Also disclosed is an implementation of a park plug inspection kit having a base, a support arm coupled to the base and an adjustable inspection element mount that is movable along the support arm to selectively position an inspection element relative to the spark plug positioned in the analysis socket.

Also disclosed is a spark plug inspection assembly that includes a base having a plurality of legs, an analysis socket configured to receive a spark plug along an inspection axis, and one or more holder sockets configured to temporarily retain additional spark plugs that includes an inspection element that is aligned with an inspection axis defined by the base to facilitate illuminated and/or magnified inspection of an exterior surface of the spark plug.

In certain embodiments, the spark plug inspection assembly can include an inspection element that can compose one or more of a magnifier, a light source, a camera, and a display element.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is side view of an embodiment of a spark plug inspection device as disclosed herein;

FIG. 2 is a front perspective view of the spark plug inspection device of FIG. 1;

FIG. 3 is an exploded view of the spark plug inspection device of FIG. 1;

FIG. 4 is a depiction of a representative spark plug suitable for inspection using the spark plug inspection device of FIG. 1;

FIG. 5A is an upper plan view of a first embodiment of an analysis socket of the spark plug inspection device of FIG. 1;

FIG. 5B is a side cross section view of the first embodiment of the analysis socket taken along the 5B-5B line of FIG. 5A;

FIG. 5C is side a side cross section view of the first embodiment of the analysis socket taken along the 5C-5C line of FIG. 5A;

FIG. 5D is an upper plan view of a second embodiment of an analysis socket of the spark plug inspection device of FIG. 1;

FIG. 5E is a side cross section view of the first embodiment of the analysis socket taken along the 5E-5E line of FIG. 5D;

FIG. 6A is a top view of an embodiment of holder sockets of the inspection device of FIG. 1;

FIG. 6B is a cross-sectional side view of the holder socket of FIG. 6A; and

FIG. 7 is a process diagram for an embodiment of a method of inspecting one or more spark plugs as disclosed herein.

### DETAILED DESCRIPTION

Disclosed herein is a spark plug inspection assembly that can assist in the inspection and evaluation of spark plugs. Also disclosed is a method of inspecting spark plugs employing the device as disclosed that can include inspection of one or more spark plug parameters. Without being bound to any theory, it is believed that the inspection method and associated device can be used to assess engine performance and provide information and insight for performance enhancement.

In certain embodiments, the spark plug inspection assembly for inspection of spark plugs and spark plug parameters can include a base having an analysis and a spark plug holding area configured to contain at least two spark plugs in an ordered relationship. In certain embodiments, the at least one holding area is configured with two or more spark plug holder sockets configured to accommodate two or more spark plugs, the holder sockets are positioned in the holder area in any suitable arrangement. In certain embodiments, the holder area can be configured with a plurality of holder sockets that extend through the first surface of the base in a direction normal to the second surface of the base opposed to the first surface.

The base can also include or define an inspection axis on which the analysis socket can be located. The analysis socket is configured to accommodate a spark plug to be inspected. The analysis socket can be positioned along an inspection axis that runs from the first surface of the base to the opposed second surface of the base. In certain embodiments, the inspection axis can be normal to the second surface. Where desired or required, the base can be configured with a first surface, a second surface opposed to the first surface and an intermediate portion interposed between the first surface and the second surface. The analysis socket and/or holder sockets can extend from the first surface into at least the intermediate portion. In certain embodiments, the analysis socket and/or holder sockets can extend from the first surface through the intermediate portion to define an exit opening on the second surface.

As disclosed, the base of the spark plug inspection assembly also includes a support arm aperture configured to accommodate a support arm, The support arm aperture can be defined in the first surface of the base and can be positioned distal to the holding area. Where desired or required, the support arm aperture extends into the first surface of the base and the intermediate portion of the base in the direction normal to the second surface.

In certain embodiments, the spark plug inspection assembly can include a support arm that includes a first arm end, a second arm end, and an intermediate arm portion. In certain embodiments, the first arm end can be configured to be removably connected to the support arm aperture. When in position, the intermediate arm portion can extend in a direction normal to the base.

In certain embodiments, the spark plug inspection assembly can include a fixture associated with the support arm that can include an adjustable mount and an inspection extension. Where desired or required, the adjustable mount can be configured to adjustably move relative to the support arm. In certain embodiments, the adjustable mount can slide along the intermediate arm portion of the support arm. In certain embodiments, the adjustable mount can include an adjustment mechanism to control movement such as an adjustment knob and the adjustable mount can be configured to slidably mount relative to the support arm and slide along the arm intermediate portion of the support arm according to the position of the adjustment knob. Where desired or required, the inspection extension can be configured to removably receive or accommodate an inspection device in a manner that aligns the inspection device with an inspection axis. The inspection extension can extend in a direction toward the inspection axis from the adjustable mount of the fixture.

In certain embodiments, the second face of the base can define a planar lower facet that is configured to be in a movable overlying relationship with a support surface. In certain embodiments, the base can include plurality of legs extending from the planar lower face in a direction normal to the second surface to a base distance.

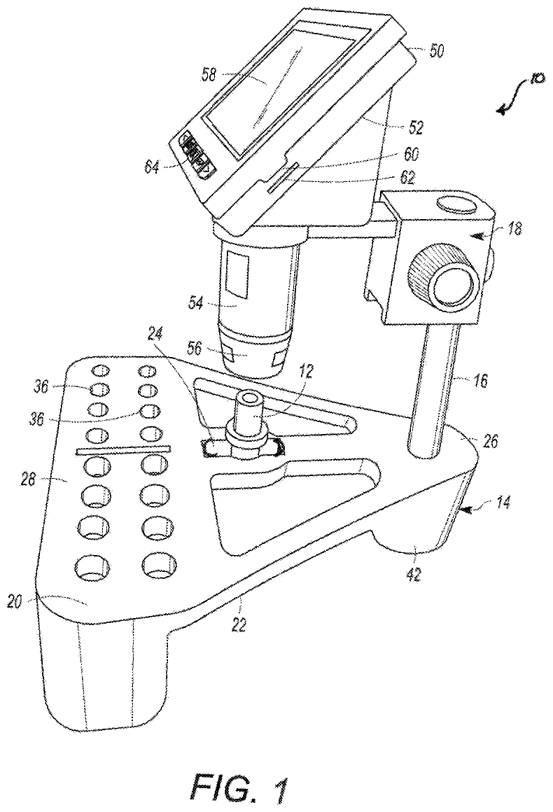

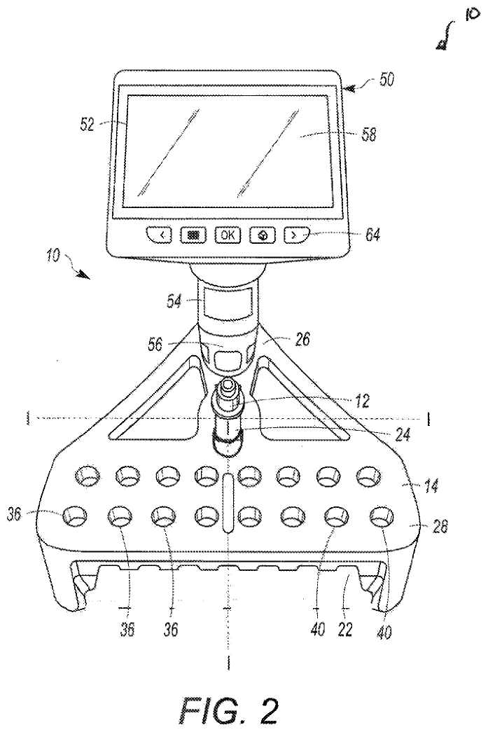

With reference to FIGS. 1 and 2, a spark plug inspection assembly 10 is shown. The spark plug inspection assembly 10 is useful for inspecting and ascertaining one or more parameters or characteristics of a spark plug such as spark plug 12. While in certain embodiments, the spark plug to be inspected may be new, it is considered to be within the purview of this disclosure to inspect spark plugs that have been used in the operation of an internal combustion engine. The physical condition of spark plugs that have been used in an internal combustion engine and its variation from new can provide insight into engine performance and can provide evidence and insight for engine modification that can lead to engine performance improvement. Non-limiting examples of indicia of engine performance that can be associated with one or more spark plugs include soot accumulation, discoloration, heat scarring and the like. Without being bound to any theory, these indicia can provide insight into engine timing modification, fuel-to-air ratio, combustion temperature and the like that can enhance performance of the associated engine. Without being bound to any theory, it is believed that assessment of other condition issues of the spark plug can be assessed and evaluated. These include, but are not limited to, conditions such as the gap between ground electrode and center electrode present in the spark plug, discoloration of metal and/or casing, the presence of foreign material such as metal, carbon or other debris or whether the composition material of the spark plug (such as ceramic) has chipped or cracked.

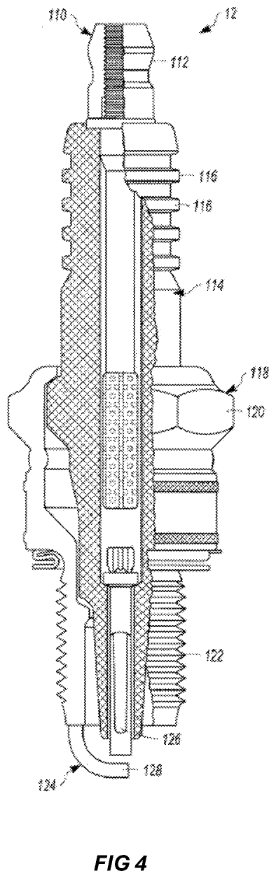

Configurations of spark plug 12 suitable for inspection and visualization can include, but not limited to, that illustrated in FIG. 4. In certain embodiments, configurations of spark plugs 12 will include a terminal 110 configured to connect to the ignition system of an internal combustion engine (not show) and can include terminal screw 112. Terminal screw 112 is connected to an insulator body 114 which can be composed of hard ceramic material of high dielectric strength. That can include one or more ribs 116 defined therein. A plug body 118 can radially overlay the insulator body 114 at a central location and can include a suitable shoulder or spanner such as hex 120 and a threaded region 122. An electrode region 124 that includes a central electrode and side electrode is located on the spark plug 12 distal to terminal 110.

Spark plugs that can be inspected using the assembly as disclosed herein can be of various types and sizes. In certain embodiments, it is contemplated that the spark plug inspection device 10 can be configured to accommodate spark plug sizes such as 8 mm. 10 mm, 12 mm, 14 mm 18 mm, 20 mm. Spark plugs which can be inspected can include those having a thread length between 6 mm and 18 m and can have a reach between 9 mm and 20 mm. It is also contemplated that the spark plug inspection device 10 can accommodate spark plugs configured with a hex between ⅝ to 13/16.

In the embodiment depicted in the various drawing figures, the spark plug inspection assembly 10 can include a base 14, a support arm 16 and a fixture 18. Base 14 can include first surface 20, second surface 22 opposed to first surface 20 and an intermediate region interposed between first surface 20 and second surface 22. The base 14 can be composed of any suitable material, including but not limited to, various polymeric material(s) metal and the like.

Base 14 can be configured as a general planar member and can have dimensions sufficient to provide stability to the spark plug assembly device 10 when in use. The base 14 can be configured to define an effective working surface in first surface 20. In certain embodiments, the first face 20 of base 14 can include an analysis socket 24, a support arm connection region 26 and a spark plug holding region 28.

In the embodiment depicted in FIGS. 1 and 2, the analysis socket 24 can be centrally located in first surface 20 with support arm connection region 26 and spark plug holding region 28 being opposed to one another and defined in the first face 20. Analysis socket 24 is configured to accommodate a spark plug 12 under inspection and can be positioned at a location defined by inspection axis I defined in device 10.

Analysis socket 24 is configured to allow the spark plug 12 to be placed and seated in the therein while aligning with the inspection axis I. In certain embodiments, analysis socket 24 can allow the spark plug 12 to be adjustable positionally while seated in the socket. In certain embodiments, the analysis socket 24 can be configured to permit the alignment of the spark plug 12 to be inspected with the visual field provided by a suitable inspection device with the central portion of the visual field defining and analysis axis A. The analysis socket 24 can also be configured to permit manipulation of the spark plug 12 that is seated in the analysis socket 24 away from alignment to at least one angle that deviates from alignment with the analysis axis A. Where desired or required, the angle of deviation can be between that sufficient to visualize various surfaces of interest on the spark plug 12. In certain embodiments the angle θ of deviation from the axis of alignment can have a value between 0.25° and 45°; between 0.25° and 30°; between 0.25° and 20°; between 0.25° and 10°; between 0.25° and 9°; between 0.25° and 8°; between 0.25° and 7°; between 0.25° and 6°; between 0.25° and 5°; between 0.25° and 4°; between 0.25° and 3°; between 0.25° and 2°; between 0.25° and 1°; between 0.5° and 45°; between 0.5° and 30°; between 0.5° and 20°; between 0.5° and 10°; between 0.5° and 9°; between 0.5° and 8°; between 0.5° and 7°; between 0.5° and 6°; between 0.5° and 5°; between 0.5° and 4°; between 0.5° and 3°; between 0.5° and 2°; between 0.5° and 1°; between 1.0° and 45°; between 1.0° and 30°; between 1.0° and 20°; between 1.0° and 10°; between 1.0° and 9°; between 1.0° and 8°; between 1.0° and 7°; between 1.0° and 6°; between 1.0° and 5°; between 1.0° and 4°; between 1.0° and 3°; between 1.0° and 2°; between 2.0° and 45°; between 2.0° and 30°; between 2.0° and 20°; between 2.0° and 10°; between 2.0° and 9°; between 2.0° and 8°; between 2.0° and 7°; between 2.0° and 6°; between 2.0° and 5°; between 2.0° and 4°; between 2.0° and 3°; between 3.0° and 45°; between 3.0° and 30°; between 3.0° and 20°; between 3.0° and 10°; between 3.0° and 9°; between 3.0° and 8°; between 3.0° and 7°; between 3.0° and 6°; between 3.0° and 5°; between 3.0° and 4°; between 5.0° and 45°; between 1.0° and 30°; between 5.0° and 20°; between 5.0° and 10°; between 5.0° and 9°; between 5.0° and 8°; between 5.0° and 7°; between 5.0° and 6°.

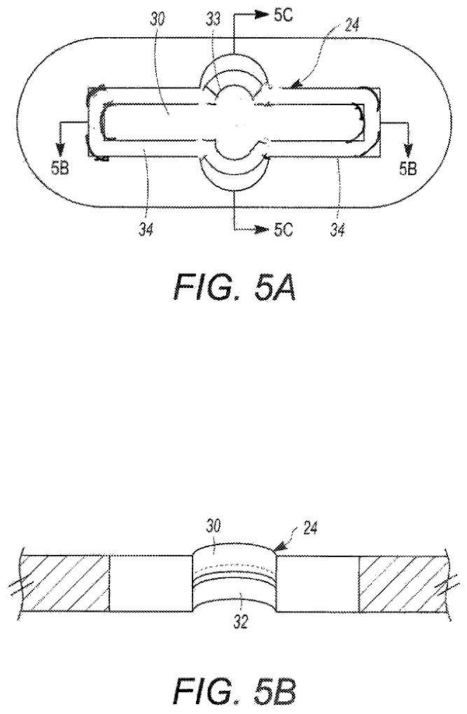

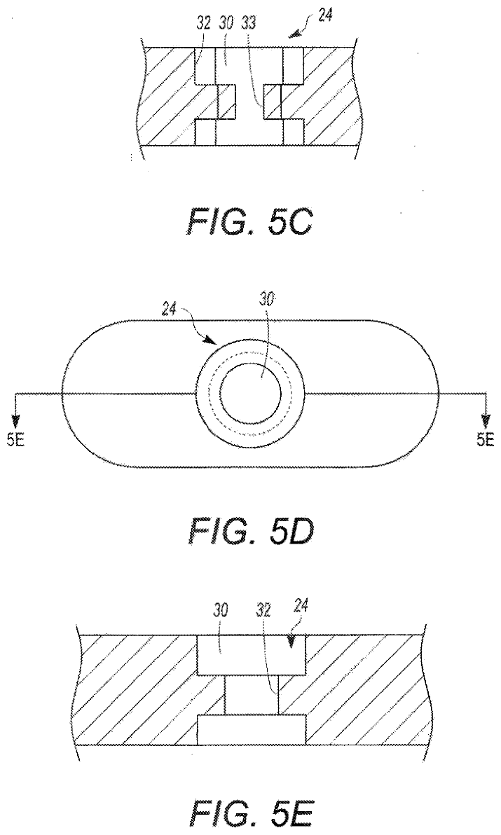

In the embodiments illustrated in FIGS. 5A, 5B and 5C and in FIGS. 5D and 5E, analysis socket 24 can be configured as through slot 30 extending from base first surface 20 to base second surface 22. Through slot 30 of analysis socket 24 defines inner wall member 32. Through slot 30 is configured with shoulder 33. Shoulder 33 projects inward from the inner wall member 33 at a location intermediate between the first surface of the base and the second surface of the base. The shoulder 33 can be continuous or intermittent depending on the embodiment.

Through slot 30 can have any suitable configuration. In the embodiment depicted in FIGS. 5D and 5E, the through slot 30 is generally cylindrical. In the embodiment depicted in FIGS. 5A, 5B and 5C is configured as a cylindrical element having at least one slot extension 34. Where desired or required, the one or more slot extensions can be contiguous with the and projecting from the inner wall member.

Where desired or required, the through slot 30 can have two opposed slot extensions 34. In certain embodiments in which the through slot 30 has one or more slot extensions 34, it is contemplated that the shoulder 33 will be discontinuous. In the embodiment depicted in FIGS. 5D and 5E, the shoulder 33 is present as two members projecting from the inner wall member 33 with breaks or openings at the junction between the through slot 30 and the respective slot extension(s) 34.

The shoulder 33 can be configured to interface with hex 120 defined on the spark plug 12 to be inspected to maintain the spark plug 12 in position in the analysis socket 24. Where desired or required, the through slot can be configured to permit the spark plug 12 to be oriented in an upright orientation relative to base 14. Where desired or required, the through slot can be sized to permit angular movement of the spark plug 12 in the analysis socket 24 away from upright to facilitate inspection.

In certain embodiments, base 14 also includes a spark plug holder region 28 configured to maintain one or more spark plugs in an organized manner. Where desired or required, the holder sockets 36 can be circular slots that are configured to accommodate spark plugs such as spark plug 12 placed into the holder sockets 36 and to keep the spark plugs fixed in an upright position.

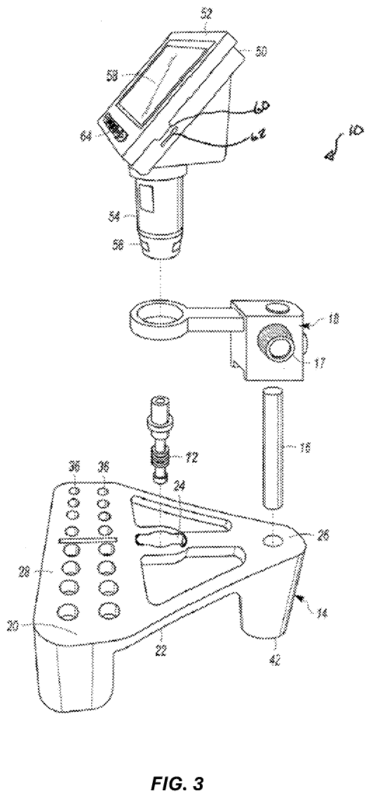

In the embodiment depicted in FIGS. 1, 2 and 3, the spark plug holder region 28 has sixteen holder sockets 36 and can accommodate a number of spark plugs sufficient to equip engines such as eight-cylinder internal combustion engines, etc. It is contemplated that base 14 can be designed to include additional or fewer holder sockets 32 at any suitable location associated with the first surface 20 of the base 14. In the embodiment depicted in FIGS. 1, 2 and 3, the spark plug holder region 28 is distal to arm member socket 26. The analysis socket 12 is located between the holder socket region 28 and the arm member socket 26

In the embodiment depicted in FIGS. 1, 2 and 3, the spark plug holder region 28 has a plurality of holder sockets 36 configured to removably receive spark plugs to be inspected. In certain embodiments, one or more of the holder sockets 36 can be configured as a detent or channel extending into the central region of the base 14 to a distance sufficient to securely receive a spark plug and maintain the spark plug in position until it is required for inspection and/or installation in a engines cylinder and/or disposal.

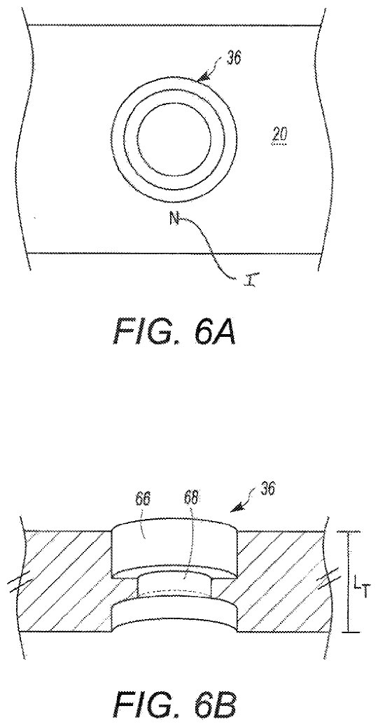

In certain embodiments, one or more holder sockets 36 can be configured as through slots having an inner wall member 66 and a shoulder 68 projecting from the inner wall member 66 at a location intermediate to the respective ends of the inner wall member 66. In the embodiment as depicted in FIGS. 6A and 6B, one or more of the holder sockets 36 can be configured as through slot(s) having an opening or aperture in first surface 20 of base 14 and connecting to an opening or aperture defined in the second face 22 of base 14. Where desired or required, the through slot can have a longitudinal value L_{T} that is less than the length L_{S} of the associated spark plug. In certain embodiments, the longitudinal value of the through slot will be configured such that a portion of the spark plug projects outward from the lower surface of the base.

Where desired or required, one or more of the holder sockets 36 can be associated with identifying indicia 40 such as numbers, letters or the like.

As illustrated in FIGS. 1, 2, and 3, the support arm aperture 26 can be a circular hole that extends through the first surface 29 into the body of base 14. In the embodiment depicted, the support arm aperture is positioned at a location distal to the spark plug holder region 28. In embodiments in which base 14 includes a plurality of legs projecting downward from the second surface of base 14, the support arm aperture 26 can be positioned proximate to one of the legs such as leg 42. The support arm aperture 26 can be configured to stably and removably receive support arm 16.

The spark plug inspection assembly 10 also includes a support arm 16 connected to base 14 that is configured to receive a fixture such as support arm mount 18 in cantilevered relationship to support arm 16 over base 14. Support arm 16 can have a first arm end, a second arm end, and an intermediate arm portion, first arm end of the support arm configured to be removably mounted to the support arm aperture, the intermediate arm portion extends in a direction normal to the first surface of the base.

A fixture such as support arm mount 18 can include an adjustable mount and an inspection extension. Where desired or required, the adjustable mount of the fixture is configured to slidably mount to the support arm and slide along the arm intermediate portion of the support arm according to positioning of an adjustment mechanism such as adjustment knob 17, or the like. The fixture can also include inspection extension configured to accommodate an inspection device that aligns with the inspection axis, the inspection extension extending in a direction toward the inspection axis I from the adjustable mount of the fixture.

In certain embodiments the inspection device 50 can include one or more of the following elements to support inspection operations. It is contemplated that one or more of the elements can be integrated into a unitary housing such as housing 52. It is also considered within the purview of this disclosure that one or more of the elements discussed can be separate or external to housing 52 where desired or required.

In the embodiment as depicted in FIGS. 1, 2 and 3, the inspection device 50 can include a light source such as light source 54 capable of directing light toward the analysis socket 12 and toward any spark plug under inspection present in the analysis socket 12. Light source 54 can be configured to provide enhanced illumination to the areas of interest on the spark plug under inspection. The light source can be any suitable light emitting device. Where desired or required, the light source can be one that emits full visible spectrum light. It is also contemplated that the light source can be one that can be adjusted to emit light of varying spectra in order to enhance inspection operations.

The inspection device 50 can also include visualization enhancement aides 56 such as magnification devices, viewports and the like. Where desired or required, the visualization aides can be adjustable. In certain embodiments the viewports, camera device and the like can be optically aligned with mechanisms such as the magnification device to capture at least one magnified image of the spark plug under inspection. Image captures can be transient as when displayed in real time on a suitable display device or can be more permanently retained in the inspection device 50.

In certain embodiments the magnification device such as that present in the inspection device 50 can provide adjustable magnification levels sufficient to inspect desired details and physical parameters associated with the spark plug of interest between 10×and 1000×, between 50×and 1000×; between 100×and 1000×, between 250×and 1000×, between 500×and 1000×, between 750×and 1000×. It is also within the purview of this disclosure to employ devices that can provide higher magnifications where desired or required. In certain embodiments, the magnifications greater than 1000×; between 1000×and 10000×; between 2000×and 10000×; between 3000×and 10000×; between 4000×and 10000×; between 5000× and 10000×; between 6000×and 10000×; between 7000×and 10000×; between 8000×and 10000×; between 9000×and 10000×. In certain embodiments, the magnification level can be greater than 10000×; between 10000×and 50000×; between 20000×and 50000×; between 30000×and 50000×; between 40000×and 50000×.

While direct visualization of the spark plug under inspection is considered to be within the purview of the present disclosure, in certain embodiments, the visualization device 50 can include a suitable camera device (not shown) which can capture image(s) of the spark plug to be visualized and present them on a suitable feedback device. In the embodiment depicted, the feedback device can include display screen 58. It is also considered to be within the purview of this disclosure that inspection device can be configured to display relevant inspection data in the form of measurements, parametric value and the like if desired or required. Where desired or required, the inspection device 50 can also include means for recording, storing and/or transmitting inspection data. One non-limiting example of data storage devices includes data port 60 and data storage card 62. It is also contemplated that the inspection device can be equipped with on board data storage mechanisms and/or mechanisms for transmitting data to remote locations, including but not limited to data cables, wireless data transmission and the like.

The inspection device 50 can be a suitable apparatus that can include a light source directing light toward the analysis socket 24. The inspection device can also include a magnification device housed within the inspection device configured to provide magnification of a spark plug 12 in position in the analysis socket 24 under inspection. Where desired or required, the inspection device 18 can also include a camera device optically aligned with the magnification device configured to capture at least one magnified image of the spark plug under inspection.

In certain embodiments, inspection device 58 can include one or more user interface mechanisms. Non-limiting examples of such mechanisms include graphic user interface mechanisms (not shown), remote control input devices, physical display controls 64 as well as combinations thereof. Non limiting examples of parameters that may be controlled include focus, contrast, in/out zoom image capture, light intensity, light wavelength and the like.

Also disclosed is a method for inspecting a spark plug and/or assessing engine performance. In certain embodiments of the method as disclosed herein, one or more spark plugs can be inspected for one or more physical attributes or characteristics. In certain embodiments, the spark plugs that are inspected have been employed in an internal combustion engine. In certain embodiments, the method as disclosed herein can be employed to inspect the exterior and/or interior surface(s) of one or more spark plug(s) that have been employed in an internal combustion engine.

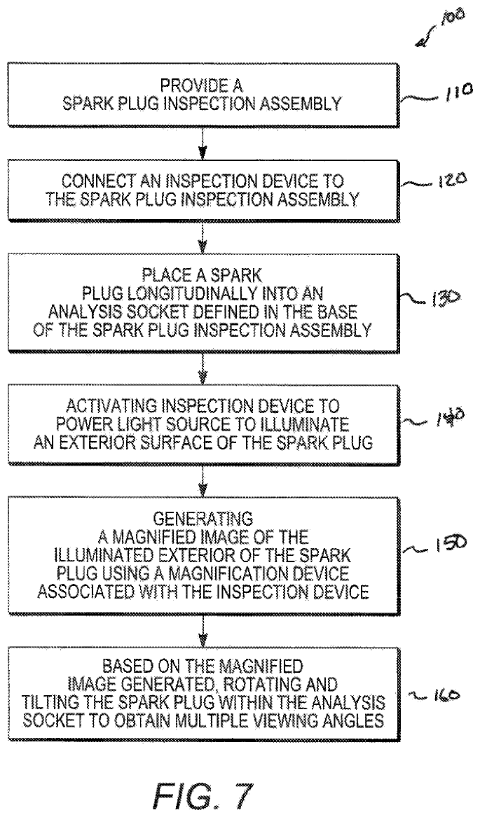

In certain embodiments, the device as disclosed herein can be employed in embodiments of the method for inspecting one or more spark plugs in order to gain insight into engine performance and to formulate recommendations for engine performance enhancement. An embodiment of the method as disclosed herein is presented in FIG. 7. The method 100 can include the step of providing the spark plug inspection assembly as disclosed herein as at reference numeral 110. As broadly construed the spark plug assembly can include a base having a first surface, a second surface, an intermediate portion between the first surface and the second surface. The base has an analysis socket configured to accommodate a spark plug under inspection with the analysis socket positioned along an inspection axis and defined in the base with the analysis socket extending through the first surface of the base and into intermediate portion of the base in a direction normal to the second surface. The base also includes a plurality of holder sockets configured to accommodate two or more spark plugs with the plurality of holder sockets positioned in a holding region 28 on the base. The plurality of holder sockets each extend through the first surface of the base and into a region in the intermediate portion of the base in the direction normal to the second surface. The base also includes a support arm aperture configured to accommodate a support arm positioned distal to the holding region 28 on the base. Where desired or required, the support arm aperture extends into the first surface of the base and the intermediate portion of the base in the direction normal to the second surface.

The method 100 further includes the step of connecting a suitable inspection device in operative position relative to the spark plug inspection assembly at Reference numeral 120. A suitable inspection device can include light source directing light toward the analysis socket defined in the spark plug inspection assembly as well as a magnification device housed within the inspection device configured to provide magnification of the spark plug under inspection and a camera device optically aligned with the magnification device configured to capture at least one magnified image of the spark plug under inspection. Where desired or required, the cameral device and the magnification device of the inspection device can include or be operatively coupled to a display device configured to present magnified images of the spark plug under inspection.

The method 100 can include the step of placing a spark plug longitudinally into the analysis socket defined on the base of the spark plug inspection assembly for inspection thereby enabling visual access to the surfaces of interest on the spark plug as at reference numeral 130; as well as activating the inspection device to power the light source to illuminate the surface of the spark plug to produce an illuminated surface of the spark plug as at reference numeral 140. It is contemplated that the illuminated surface can be located on an exterior spark plug surface, an interior spark plug surface or both. It is also within the purview of the method as disclosed herein that multiple regions of the exterior surface of the spark plug, the interior surface or both can be inspected.

The method 100 also includes the step of generating a magnified image of the illuminated exterior surface of the spark plug using the magnification device disposed within the inspection device as at reference numeral 150. Based on the magnified image generated, the spark plug under inspection can be rotated and/or tilted within the analysis socket to obtain multiple viewing angles as at reference numeral 160.

Where desired or required, images can be captured and maintained or transmitted to other remote sources. By way of non-limiting example, the information can be transferred and maintained devices such as data storage card 62 and or transmitted via data storage port 60, WIFI, Bluetooth and the like. Such information can be studied and analyzed by any suitable manner to formulate and derive recommendations for adjustment to one or more engine performance parameters based on observed condition of the spark plug. Engine parameter adjustment can include one or more of firing timing, fuel to air ratio in a given cylinder and the like.

It is contemplated that the analysis socket 12 can receive the spark plug to be inspected so that either the terminal screw 112 or the electrode region 124 is presented for inspection. It is believed that inspection of the condition of the electrode region 124 may provide greater insight into engine performance and formulation of recommendation for enhancement of engine performance in certain applications. Non-limiting examples of areas of inspection of the spark plug include quality and/or discoloration of the ceramic/porcelain region such as casing 126 of the spark plug 110, discoloration and or general appearance of the regions such as threads 121 located in lower region 122, cracking and/or chipping as well as general surface damage present in regions such as insulator body 114 and/or ribs 116

It is also considered to be with the purview of the method disclosed herein that the process can be repeated for one or more additional spark plugs of interest. In certain analysis scenarios, the multiple spark plugs can be derived from multiple cylinders from a single engine. Analysis and inspection of wear and use patterns on the various spark plugs can be collected and studied to ascertain engine performance and/or formulate engine performance parameter modifications. Where desired or required, multiple spark plugs can be organized in the spark plug holding region 28 as in holding sockets 30 and inspected in sequence as desired by the user. It is also contemplated that the spark plug holding region 28 can be configured with sufficient holding sockets 30 that can be grouped and organized in cohorts of six sockets, eight sockets, or more in order to correspond to the number of cylinders present in an engine of interest. It is also contemplated that the holder region 28 can include two or more cohorts of eight or more in order to accommodate multiple groups of spark plugs in an orderly manner. Such arrangements can support multiple inspection schemes, for example switching one or more specific select spark plugs into an engine after engine parameter modifications in order to ascertain the effect of a given modification by providing follow-on inspection after engine operation. Thus, the device 10 can be employed to facilitate and support and inspect interactive modification of one or more engine parameters to enhance engine performance.

Where desired or required, the spark plug inspection device as disclosed herein can be present as a spark plug inspection kit for stable inspection of spark plugs and one or more spark plug parameters. The spark plug inspection kit can include a base including a first surface, a second surface and an intermediate portion disposed between the first surface and the second surface, a support arm configured to be removably attachable to the base and to project upward from the first surface when the device is in the use position. The spark plug inspection kit also includes a removable fixture device including an adjustable mount and an inspection extension. The fixture device is configured to be mountable on the support arm and the inspection extension is configured to removably receive an inspection device. The base includes an analysis socket defined in the first face that can be configured to accommodate a spark plug to be analyzed. The analysis socket is positioned along an inspection axis and can be defined on the first surface of the base and can extend into the intermediate portion of the base in a direction normal to the second surface. The analysis socket is configured to removably couple with the spark plug to be analyzed without an electrical connection wherein the analysis socket is configured to permit at least one of rotation of the spark plug to be analyzed relative thereto and angular adjustment of the spark plug to be analyzed relative to the analysis socket. In certain embodiments, the analysis socket defined in the base is a through shaft that extends from the first surface of the base to the second surface of the base, with the analysis socket having an inner wall member and may include a shoulder projecting inward from the inner wall member at a location between the first surface of the base and the second surface of the base.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A spark plug inspection assembly for inspection of spark plugs and spark plug parameters, comprising:
a base, the base including a first surface, a second surface, an intermediate portion between the first surface and the second surface, the base comprising:
an analysis socket configured to accommodate a spark plug under inspection, the analysis socket positioned along an inspection axis and defined in the base, the analysis socket extends through the first surface of the base and the intermediate portion of the base in a direction normal to the second surface;
a plurality of holder sockets configured to accommodate two or more spark plugs, the plurality of holder sockets positioned in a holding area on the base, wherein the plurality of holder sockets each extend through the first surface of the base and into a region in the intermediate portion of the base in the direction normal to the second surface; and
a support arm aperture configured to accommodate a support arm, the support arm aperture positioned distal to the holding area on the base, wherein the support arm aperture extends into the first surface of the base and the intermediate portion of the base in the direction normal to the second surface;
a support arm including a first arm end, a second arm end, and an intermediate arm portion, the first arm end of the support arm configured to be removably mounted to the support arm aperture, the intermediate arm portion extends in a direction normal to the first surface of the base; and
a fixture including an adjustable mount and an inspection extension, the adjustable mount includes an adjustable knob, the adjustable mount of the fixture is configured to slidably mount to the support arm and slide along the arm intermediate portion of the support arm according to positioning of the adjustable knob, the inspection extension configured to accommodate an inspection device that aligns with the inspection axis, the inspection extension extends in a direction toward the inspection axis from the adjustable mount of the fixture.

2. The spark plug inspection assembly of claim 1 wherein the second surface of the base defines a planar lower face configured to be in movable overlying relationship with a support surface.

3. The spark plug inspection assembly of claim 2 wherein the second surface of the base defines a planar lower face configured to be in movable overlying relationship with a support surface.

4. The spark plug inspection assembly of claim 3 wherein the base further comprises a plurality of legs extending from the planar lower face in a direction normal to the second surface to a base distance.

5. The spark plug inspection assembly of claim 1 further comprising an inspection device connected to the fixture, the inspection device comprising;
a light source directing light toward the analysis socket;
a magnification device housed within the inspection device configured to provide magnification of the spark plug under inspection;
a camera device optically aligned with the magnification device configured to capture at least one magnified image of the spark plug under inspection.

6. The spark plug inspection assembly of claim 5 wherein the inspection device further comprises:
a display operatively connected to the camera device and the magnification device and configured to present magnified images of the spark plug under inspection.

7. The spark plug inspection assembly of claim 3 wherein the analysis socket defined in the base is a through slot that extends from the first surface of the base to the second surface of the base, the analysis socket having an inner wall member and a shoulder projecting inward from the inner wall member and a location between the first surface of the base and the second surface of the base.

8. The spark plug inspection assembly of claim 7 wherein the analysis socket further comprises at least one slot extension contiguous with and projecting from the inner wall member.

9. A spark plug inspection kit for stable inspection of spark plugs and spark plug parameters, comprising:
a base including a first surface, a second surface, an intermediate portion disposed between the first surface and the second surface, the base comprising:
an analysis socket configured to accommodate a spark plug to be analyzed, the analysis socket positioned along an inspection axis and integral with the base, the analysis socket defined on the first surface of the base and extending into the intermediate portion of the base in a direction normal to the second surface, wherein the analysis socket is removably mechanically coupled with the spark plug to be analyzed without an electrical connection and wherein the analysis socket is configured to permit and least one of rotation of the spark plug to be analyzed relative thereto and angular adjustment of the spark plug to be analyzed relative to the analysis socket;
a support arm removably attachable to the base and projecting upward from the first surface; and
a fixture including an adjustable mount and an inspection extension, the fixture slidably mountable on the support arm, where the inspection extension is configured to removably receive an inspection device.

10. The spark plug inspection kit of claim 9 wherein the analysis socket defined in the base is a through shaft that extends from the first surface of the base to the second surface of the base, the analysis socket having an inner wall member and a shoulder projecting inward from the inner wall member and a location between the first surface of the base and the second surface of the base.

11. The spark plug inspection kit of claim 10 wherein the analysis socket further comprises at least one slot extension contiguous with and projecting from the inner wall member.

12. The spark plug inspection kit of claim 9 wherein the base further comprises a plurality of legs extending from the second surface in a direction normal to the second surface to a base distance.

13. The spark plug inspection kit of claim 9 wherein the base further comprises a plurality of holder sockets configured to accommodate two or more spark plugs, the plurality of holder sockets positioned in a holding area on the base, wherein the plurality of holder sockets each extend through the first surface of the base and at least a portion of the intermediate portion of the base in the direction normal to the first surface.

14. A method for inspecting a spark plug having a spark plug exterior surface, comprising steps of;
providing the spark plug inspection assembly of claim 1;
connecting an inspection device in operative position relative to the spark plug inspection assembly, the inspection device comprising
a light source directing light toward the analysis socket;
a magnification device housed within the inspection device configured to provide magnification of the spark plug under inspection;
a camera device optically aligned with the magnification device configured to capture at least one magnified image of the spark plug under inspection; and
a display operatively connected to the camera device and the magnification device and configured to present magnified images of the spark plug under inspection;
placing a spark plug longitudinally into the analysis socket on the base of the spark plug inspection assembly for inspection enabling visual access to the exterior surface of the spark plug;
activating the inspection device to power the light source to illuminate the exterior surface of the spark plug to produce an illuminated surface of the spark plug;
generating a magnified image of the illuminated exterior surface of the spark plug using the magnification device disposed within the inspection device;
based on the magnified image generated, rotating and tilting the spark plug within the analysis socket to obtain multiple viewing angles.
